(19) United States
(12) Patent Application Publication
(10) Pub. No.: US 2004/0179891 A1
(43) Pub. Date: Sep. 16, 2004

(54) Adjustable pivot joint

(76) Inventors: Mervyn M. Watkins, Rancho Palos Verdes, CA (US); Michael Bird, Gardena, CA (US)

Correspondence Address: GREENBERG TRAURIG LLP, 2450 COLORADO AVENUE, SUITE 400E, SANTA MONICA, CA, 90404, US

(21) Appl. No.: 10/389,730

(22) Filed: Mar. 13, 2003

(51) Int. Cl. F16L 17/00

(52) U.S. Cl. 403/96

(57) ABSTRACT

An adjustable pivot joint includes rotation arms which, when locked, prevent pivoting about an axis. A release mechanism is used to unlock the rotation arms to allow pivoting about the axis for adjustment of the pivot joint. It is emphasized that this abstract is provided to comply with the rules requiring an abstract which will allow a searcher or other reader to quickly ascertain the subject matter of the technical disclosure. It is submitted with the understanding that it will not be used to interpret or limit the scope or the meaning of the claims.

### BACKGROUND OF THE INVENTION

1. Field of the Invention

The present invention relates to a pivot joint. More specifically, the present invention relates to an adjustable pivot joint mechanism having a releasable locking structure.

2. General Background and State of the Art

There are many examples of pivot joints in the marketplace today. Most existing products include two halves fastened together which pivot about a particular point. Some of these products include a locking mechanism which, when released, allows the pivot joint to move about a particular point. However, many pivot joints fail over time due to frequent twisting between two half joints. Other pivot joints are heavy and expensive to manufacture.

### INVENTION SUMMARY

In one aspect of the present invention, a pivot joint includes a first rotation arm and a second rotation arm, the first rotation arm coupled to an engagement piece having at least one portion with an angled perimeter, and the second rotation arm having a locking portion also having an angled perimeter, wherein the angled perimeters of the at least one portion of the engagement piece and the locking portion allow the locking portion to receive the engagement piece to provide a locking mechanism for the pivot joint. The pivot joint also includes a pivot piece about which the first rotation arm and the second rotation arm are rotatable, and a spring mechanism positioned around the pivot piece and between the first rotation arm and the second rotation arm. A release mechanism of the pivot joint has a series of pins, the second rotation arm having a series of holes through which the series of pins are positioned, wherein the series of pins extend through the series of holes to move the engagement piece against the spring mechanism and out of the locking portion when the release mechanism is activated to allow at least one of the first rotation arm and the second rotation arms to move relative to the other.

In another aspect of the present invention, a pivot joint includes a rotation mechanism having a first rotation arm coupled to an engagement piece and a locking portion recessed within a second rotation arm, the engagement piece having a plurality of teeth, and the locking portion having a plurality of grooves, such that when the engagement piece is positioned within the locking portion and the plurality of teeth and the plurality of grooves are aligned together, the rotation mechanism lockably engages the first rotation arm and the second rotation arm. The pivot joint also includes a release mechanism configured to disengage the first rotation arm and the second rotation arm by removing the plurality of teeth from the plurality of grooves when a spring mechanism positioned between the first rotation arm and the second rotation arm is compressed.

In yet another aspect of the present invention, a method of pivoting a joint apparatus includes providing a first rotation arm and a second rotation arm, the first rotation arm coupled to an engagement piece having at least one portion with a sloped perimeter, and the second rotation arm having a locking portion also having a sloped perimeter capable of receiving the at least one portion of the engagement piece the method also includes releasing the engagement piece from the locking portion by moving the first rotation arm to apply pressure against a spring mechanism, rotating at least one of the first and second rotation arms around a pivot piece, and locking the first and second rotation arms in a desired position by releasing pressure on the spring mechanism and engaging the engagement piece and the locking portion to prevent the first and second rotation arms from moving relative to each other.

In another aspect of the present invention, a pivot joint includes a plate system having a first pair of joint plates, a first clutch plate, a second pair of joint plates, and a second clutch plate, the first and second clutch plates each having a grooved portion such that the first and second clutch plates are interlockable by engaging the grooved portions in each of the first and second clutch plates. The pivot joint also includes a spring mechanism positioned between the second clutch plate and one joint plate in the second pair of joint plates, and a pivot piece about which at least one joint plate in the first pair of joint plates and the first clutch plate are rotatable.

In still another aspect of the present invention, a pivot joint includes a plate mechanism having a first clutch plate and a second clutch plate capable of lockably engaging, each of the first and second clutch plates having an elevated portion with a plurality of grooves and a plurality of bars therein such that when the elevated portions of each of the first and second clutch plates are aligned together, the plurality of bars of one of the first and second clutch plates lockably engage with the plurality of grooves of the other of the first and second clutch plate. The pivot joint also includes a release mechanism having a series of pins configured to disengage the first clutch plate from the second clutch plate when the series of pins pushes the second clutch plate against a spring mechanism.

In yet another aspect of the present invention, a method of pivoting a joint apparatus includes providing a plate system including a first pair of joint plates, a first clutch plate, a second pair of joint plates, and a second clutch plate, the first and second clutch plates each having grooved portions such that the first and second clutch plates are securable by interlocking the grooved portions in each of the first and second clutch plates. The method also includes releasing the first and second clutch plates by activating a series of pins to push the second clutch plate against a spring mechanism, rotating at least one joint plate in the first pair of joint plates around a pivot piece, and locking the first and second clutch plates in a desired position by deactivating the series of pins to release pressure on the spring mechanism and engage the grooved portions on the first and second clutch plates to prevent the first and second clutch plates from moving relative to each other.

In another aspect of the present invention, a method of pivoting a joint apparatus including providing a plate system having a pair of clutch plates each having grooved portions that allow the pair of clutch plates to interlock when interlocked together, releasing the pair clutch plates by activating a release mechanism to force the pair of clutch plates apart, rotating a first clutch plate in the pair of clutch plates about a pivot piece, and locking the pair of clutch plates in a desired position by deactivating the release mechanism allowing the grooved portions on the pair of clutch plates to engage each other and prevent the pair of clutch plates from moving relative to each other.

It is understood that other embodiments of the present invention will become readily apparent to those skilled in the art from the following detailed description, wherein it is shown and described only exemplary embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWINGS

Aspects of the present invention are illustrated by way of example, and not by way of limitation, in the accompanying drawings wherein:

FIG. 1 is a perspective view of components of the pivot joint apparatus of the present invention;

FIG. 2 is a more detailed perspective view of components of the pivot joint apparatus than that shown in FIG. 1;

FIG. 3 is a close-up view of the particular components of the pivot joint apparatus;

FIG. 4 is a side view of an engagement piece of the pivot joint apparatus;

FIG. 5 is a top view of the engagement piece of the pivot joint apparatus;

FIG. 6 is a top view of one rotation arm of the pivot joint apparatus;

FIG. 7 is a perspective view of another rotation arm of the pivot joint apparatus;

FIG. 8 is a top view of another rotation arm of the pivot joint apparatus;

FIG. 9 is an enlarged perspective view of the pivot joint apparatus of the present invention;

FIG. 10 is a perspective view of a release mechanism of the pivot joint apparatus;

FIG. 11 is a diagrammatic view of locking components of the present invention;

FIG. 12 is a cross-sectional view of a pivot joint apparatus according to one embodiment of the present invention;

FIG. 13 is a perspective view of particular plate components of the pivot joint apparatus according to one embodiment of the present invention;

FIG. 14 is a perspective view of the pivot joint apparatus according to one embodiment of the present invention;

FIG. 15 is a side view of the pivot joint apparatus according to one embodiment of the present invention; and

FIG. 16 is another side view of the pivot joint apparatus according to one embodiment of the present invention.

### DETAILED DESCRIPTION OF THE EMBODIMENTS

The detailed description set forth below in connection with the appended drawings is intended as a description of exemplary embodiments in which the present invention can be practiced. The term “exemplary” used throughout this description means “serving as an example, instance, or illustration,” and should not necessarily be construed as preferred or advantageous over other embodiments. The detailed description includes specific details for the purpose of providing a thorough understanding of the present invention. However, it will be apparent to those skilled in the art that the present invention may be practiced without these specific details.

In an exemplary embodiment of the present invention, an adjustable pivot joint apparatus is provided having rotation components which, when separated, allow the apparatus to pivot about an axis. The apparatus also includes a release mechanism and a spring mechanism. The rotation components prevent the apparatus from pivoting about the axis when in a locked position.

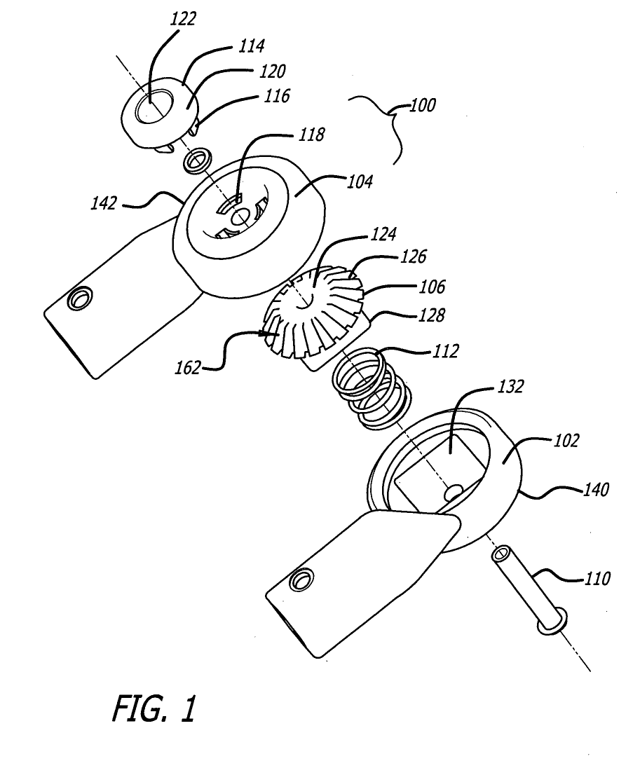

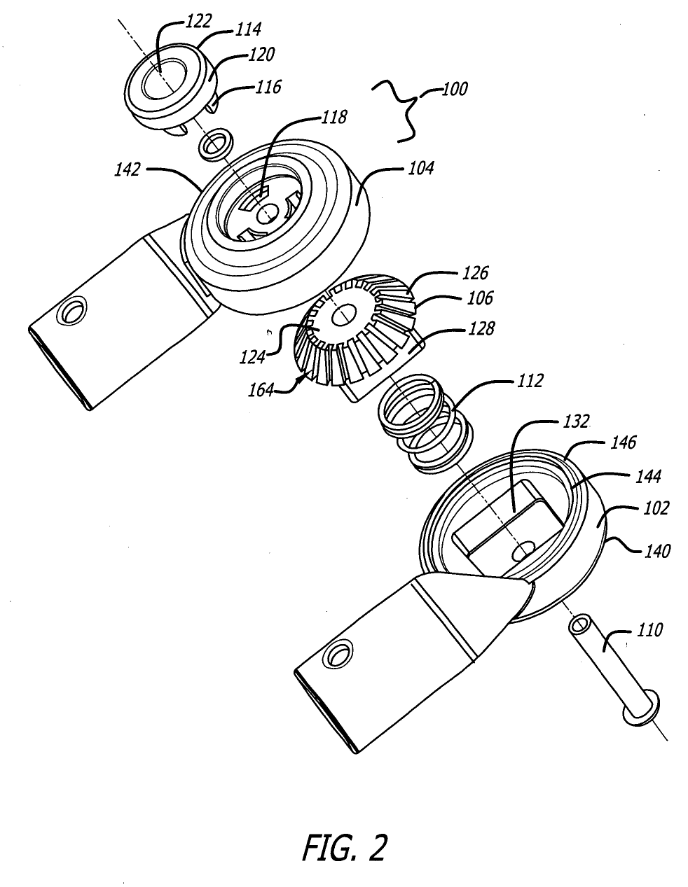

FIG. 1 is a perspective view of a pivot joint apparatus 100 according to the present invention. FIG. 2 is a more detailed perspective view of components of the pivot joint apparatus 100 than that shown in FIG. 1. The pivot joint apparatus 100 shown in FIG. 1 and FIG. 2 includes a rotation mechanism having a first rotation arm 102 and a second rotation arm 104. The rotation mechanism also includes an engagement piece 106. The first rotation arm 102 may be coupled to the engagement piece 106. The second rotation arm 104 includes a locking portion 108 (not shown in FIG. 1 or FIG. 2) capable of receiving the engagement piece 106. The locking portion 108 may be recessed within the second rotation arm 104.

The pivot joint apparatus 100 of the present invention may be used with any device, apparatus, or article of manufacture requiring an adjustable pivot joint. In one embodiment of the present invention, the pivot joint apparatus 100 is configured to have a range of adjustment of 180 degrees. One example of the use of a pivot joint apparatus 100 according to the present invention is in wheelchairs or strollers. Often, occupants of wheelchair or strollers must adjust the positioning of leg or arm rests or other components. This can be cumbersome for some occupants. Using the present invention, an occupant activates the release mechanism, adjusts the pivot joint apparatus and the component connected thereto to a desired position, and then deactivates the release mechanism. Additionally, the locking feature of the pivot joint apparatus 100 adds strength and durability to the pivot joint component of the wheelchair or stroller. It is noted that although various aspects of the present invention are described in the context of wheelchair and strollers, those skilled in the art will appreciate that the pivot joint apparatus 100 of the present invention is likewise suitable for use in various other mechanical environments. Accordingly, any reference to wheelchairs and strollers is intended only to illustrate the inventive aspects of the present invention, with the understanding that such inventive aspects have a wide range of applications.

FIG. 1 and FIG. 2 also show a pivot piece 110, a spring mechanism 112, and a release mechanism 114 having a head portion 120, a button 122, and a series of pins 116. The second rotation arm 104 includes a series of holes 118 which are capable of receiving the series of pins 116. The pivot piece 110 extends centrally through the pivot joint apparatus 100 through the first rotation arm 102, the spring mechanism 112, the engagement piece 106, the second rotation arm 104, and the release mechanism 114. The pivot piece 110 provides a point about which the rotation arms 102 and 104 of the pivot joint apparatus 100 rotate. The spring mechanism 112 may be a coil, which is wound around the pivot piece 100, and positioned between the first rotation arm 102 and the engagement piece 106.

In one embodiment, each of the first and second rotation arms 102 and 104 includes a first end which is substantially circular. This first end is coupled to a substantially hollow member which houses components of the device to which the pivot joint apparatus 100 is attached. Within a first end 140 of the first rotation arm 102 is a recessed portion 132, which is capable of receiving the second portion 128 of the engagement piece. Within a first end 142 of the second rotation arm 104 is the locking portion 108, which is capable of receiving the first portion 124 of the engagement piece 106. In another embodiment, the first ends 140 and 142 are adapted to receive each other when the first and second rotation arms 102 and 104 come together when the engagement piece 106 engages the locking portion 108. In this embodiment, the first end 140 of the first rotation arm 102 includes a ridge 144 along a first edge 146. The first end 142 of the second rotation arm 104 includes a gap 148 within a second edge 150. The ridge 144 fits within the gap 148 when the first and second rotation arms 102 and 104 come together to provide a secure and tight closure for the pivot joint apparatus 100.

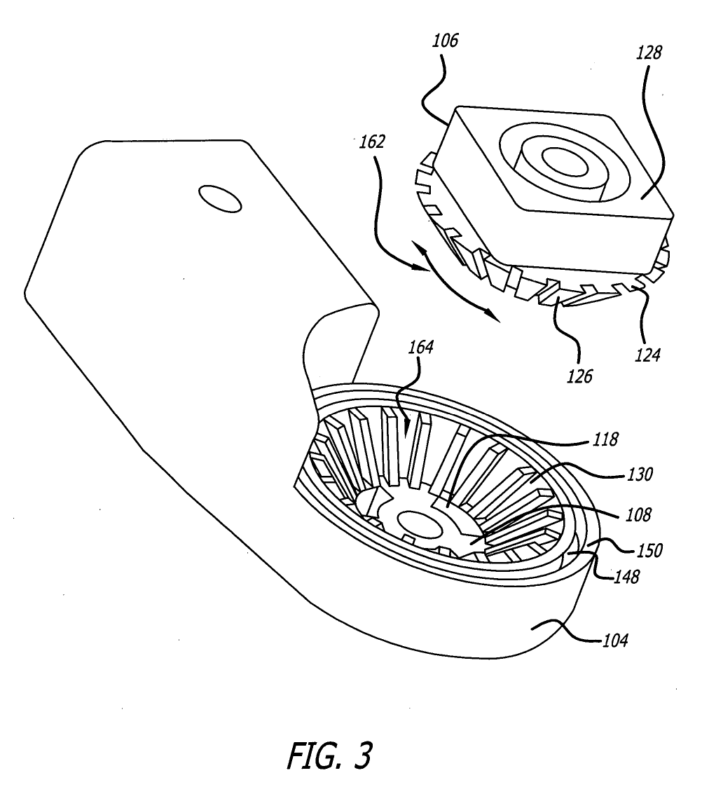

The engagement piece 106 includes first portion 124 and a second portion 128. The first portion 124 includes a plurality of teeth 126. The locking portion 108 of the second rotation arm 104 includes a plurality of grooves 130. These plurality of grooves 130 are capable of receiving the plurality of teeth 126 in the first portion 124. The first portion 124 may have an angled or sloped perimeter 162 along which the plurality of teeth 126 are aligned. The locking portion 108 may also have an angled or sloped perimeter 164 along which the plurality of grooves 130 are aligned for receiving the plurality of teeth 126 of the first portion 124. FIGS. 1-4 and 11 show the angled, or sloped, perimeter 162 of the first portion 124. FIG. 3 shows the angled or sloped perimeter 164 of the locking portion 108. In one embodiment, the first portion 124 is conical in shape, and the second portion 128 is square in shape. The first rotation arm 102 includes a recessed portion 132 for receiving the second portion 128 of the engagement piece 106.

The first portion 124 and the second portion 128 of the engagement piece 106, as well as other components of the pivot joint apparatus 100, must be able to withstand significant wear and tear over a long period of time and in a variety of weather conditions. In one embodiment, plastic and nylon are materials used to manufacture various components in the pivot joint apparatus 100, such as the engagement piece 106. It is noted that any other materials that are capable of withstanding repeated use in both severe cold and severe heat may also be used to manufacture components of the pivot joint apparatus 100.

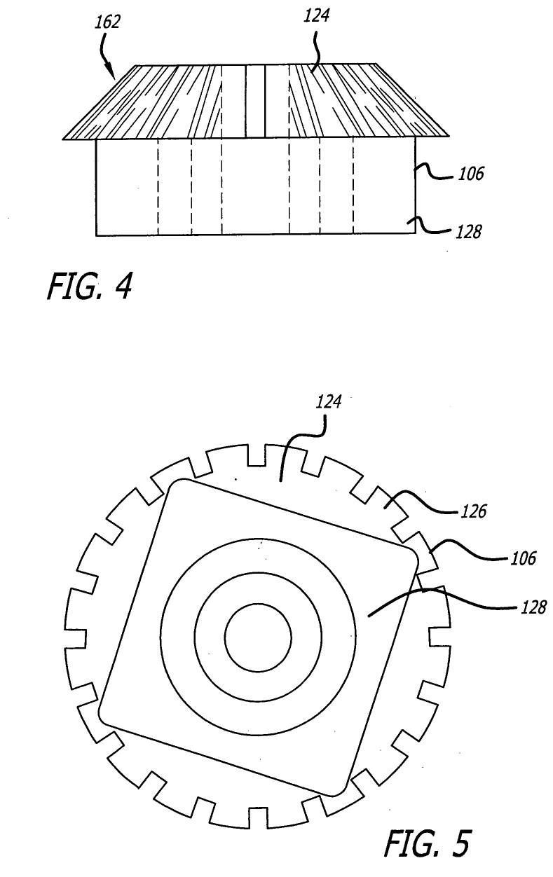

FIG. 3 is a close-up view of the particular components of the pivot joint apparatus 100, showing the second rotation arm 104 and the engagement piece 106. FIG. 3 shows the plurality of grooves 130 in the locking portion 108 of the second rotation arm 104 that are capable of receiving the plurality of teeth 126 of the first portion 124 of the engagement piece 106. FIG. 3 also shows the second portion 128 of the engagement piece 106. FIG. 4 is a close-up side view of the engagement piece 106 of the pivot joint apparatus 100. FIG. 4 shows the engagement piece 106 with the first portion 124 and the second portion 128. FIG. 5 is a close-up top view of the engagement piece 106 of the pivot joint apparatus 100, showing the second portion 128 having a substantially square shape. The first portion 124 includes the plurality of teeth 126 in FIG. 5.

The plurality of teeth 126 in the first portion 124 of the engagement piece 106 are adapted to fit into the plurality of grooves 130 in the locking portion 108. The use of the teeth and grooves design allows for stress on the contact portions of the pivot joint to be distributed over a large surface area, strengthening the overall performance of the locking mechanism and reducing the possibility of failure of the pivot joint apparatus 100. In the embodiment where the first portion 124 has a substantially conical shape, the locking portion 108 also has a substantial conical shape to receive the first portion 124. The conical configuration of the first portion 124 and the locking portion 108 allows for greater penetration of the locking element, increased surface engagement of the locking element, and redirection and reduction of the force opposing the spring mechanism 112. In another embodiment, the first portion 124, the plurality of teeth 126, the locking portion 108, and the plurality of grooves 130 all are substantially sloped with an angle of 45°.

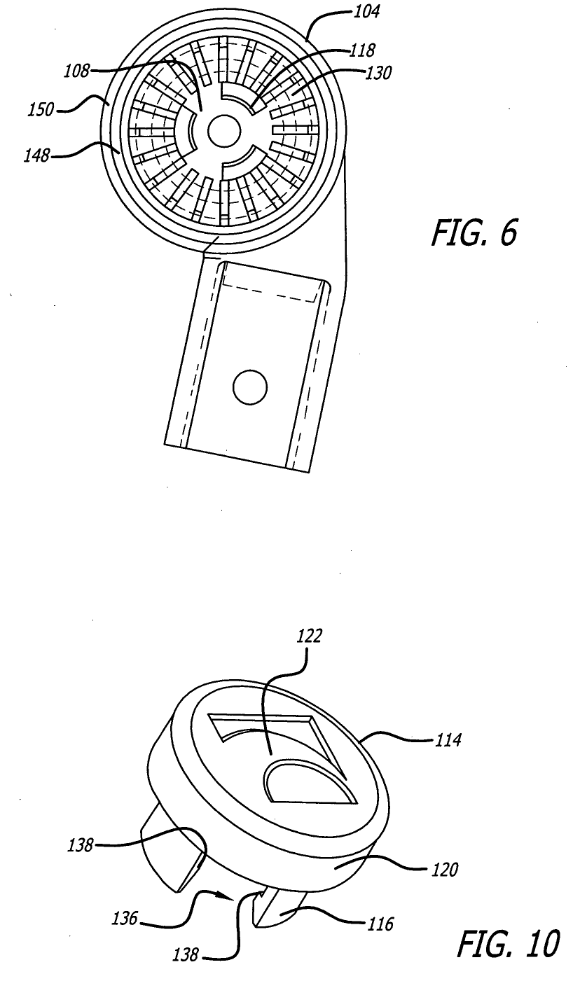

FIG. 6 is a top view of the second rotation arm 104 of the pivot joint apparatus 100. The second rotation arm 104 as shown in FIG. 6 includes the locking portion 108, which in one embodiment may be recessed within the second rotation arm 104. The locking portion 108 shown in FIG. 6 includes the plurality of grooves 130. FIG. 6 also shows a series of holes 118 in the locking portion 108 and the second rotation arm 104, through which the series of pins 116 may be positioned. FIG. 6 also shows that the locking portion 108 and the second rotation arm 104 include a pivot piece hole 134 through which the pivot piece 110 extends. The pivot piece hole 134 may be centrally positioned in the locking portion 108 and the second rotation arm 104 and may extend all the way through the pivot joint apparatus 100.

FIG. 7 is a perspective view of the first rotation arm 102 of the pivot joint apparatus 100. FIG. 7 shows the first rotation arm 102 having a recessed portion 132, into which the second portion 128 of the engagement piece 106 may be positioned. In one embodiment, the second portion 128 is substantially square in shape. In this embodiment, the recessed portion 132 in the first rotation arm 102 is also substantially square in shape to receive the second portion 128 of the engagement piece 106. FIG. 8 is a top view of the first rotation arm 102 of the pivot joint apparatus 100, also showing the recessed portion 132 into which the second portion 128 of the engagement piece 106 can be positioned.

The second portion 128 and the recessed portion 132 provide additional security for the pivot joint apparatus 100. The first rotation arm 102 engages with the second portion 128 of the engagement piece 106 to prevent rotation of the first rotation arm 102, and also to prevent rotation of the engagement piece 106 relative to the first rotation arm 102. The second portion 128 and the recessed portion 132 may be of any shape that prevents the first rotation arm 102 and the engagement piece 106 from moving relative to each other.

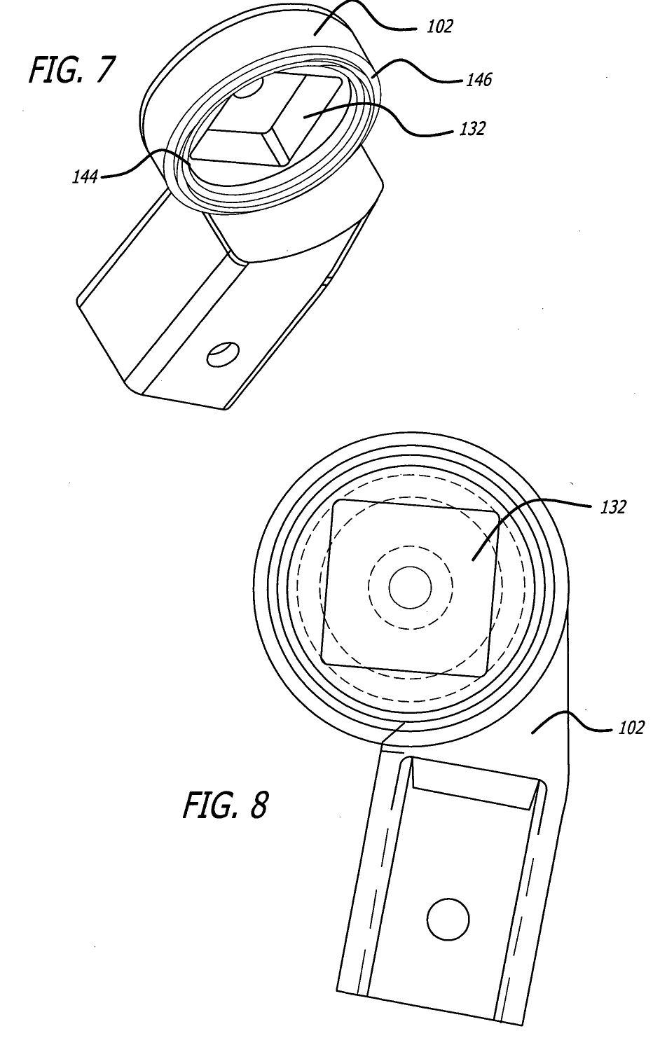

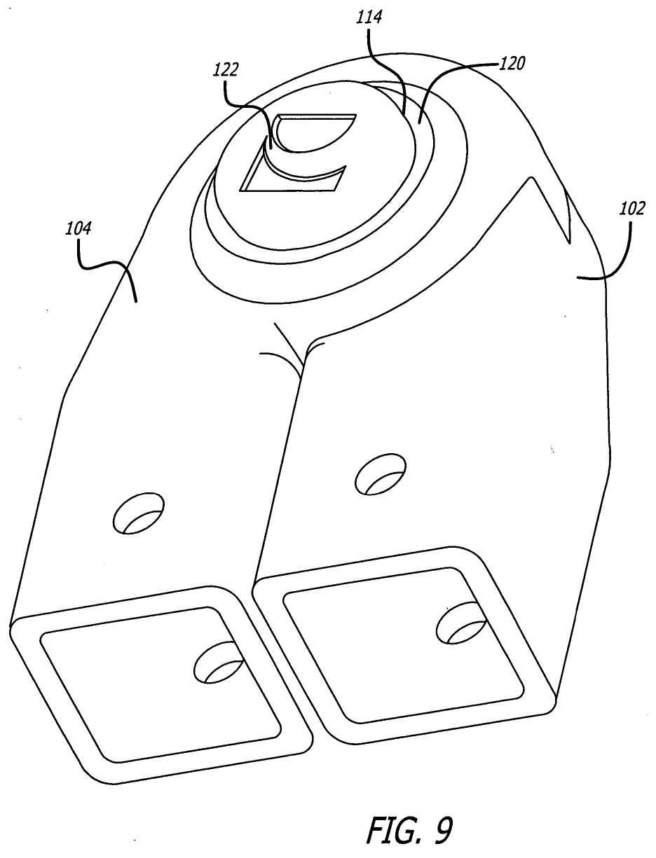

FIG. 9 is an enlarged perspective view of the pivot joint apparatus of the present invention. FIG. 9 shows the first rotation arm 102, the second rotation arm 104, and the release mechanism 114, including the head portion 120 and the button 122. The button 122 may be positioned centrally relative to the head portion 120.

FIG. 10 is a perspective view of a release mechanism 114 of the pivot joint apparatus 100. FIG. 10 shows the head portion 120 of the release mechanism 114, the button 122, and the series of pins 116. The series of pins 116 extend downward from the release mechanism 114 and the head portion 120. In one embodiment, the series of pins 116 may be curved. The series of pins 116 may also be contoured, such that one side 136 of a pin in the series of pins 116 is shaped to form a ridge 138. This contour allows the series of pins 116 to securely fit into the series of holes 118, such as by snapping into place. The contour shaping of the pins allows the series of pins 116 to fit into the series of holes 118 and prevent the pivot joint apparatus 100 from disengaging when in an locked position.

When the pivot joint apparatus 100 is locked, the spring mechanism 112 is in a substantially uncompressed state so that it biases the engagement piece 106 into the locking portion 108 of the second rotation arm 104. This provides additional security to keep the engagement piece 106, and the pivot joint apparatus 100, locked in a desired position. When the button 122 on the head portion 120 of the release mechanism 114 is pressed, the series of pins 116 are forced further through the series of holes 118. The series of pins 116 contact a side of the first portion 124 of the engagement piece 106 and cause the spring mechanism 112 to compress, allowing the first portion 124 to be pushed out of the locking portion 108, and disengaging the plurality of teeth 126 from the plurality of grooves 130. The compressing spring mechanism 112 pushes against the recessed portion 132 of the first rotation arm 102, separating the ridge 144 from the gap 148 in the second rotation arm 104 and moving the first rotation arm 102 clear of the second rotation arm 104. Full pressure on the button 122 therefore separates the engagement piece 106 from the second rotation arm 104. Because the second portion 128 of the engagement piece 106 fits within the recessed portion 132 of the first rotation arm 102, and because the shape of the recessed portion 132 and the second portion 128 allow the engagement piece 106 and the first rotation arm 102 to move together, the first rotation arm 102 and the engagement piece 106 are rotatable relative to the second rotation arm 104 about the pivot piece 110 to adjust the configuration of the pivot joint apparatus 100. The spring mechanism 112 therefore compresses enough to allow the second portion 128 to fit securely within the recessed portion 132 of the first rotation arm 102. When a user has adjusted the angle of the first rotation arm 102 relative to the second rotation arm 104 to his or her liking, pressure can be released on the button 122 to return the first portion 124 of the engagement piece 106 so that the plurality of teeth 126 once again fit within the plurality of grooves 130 in the second rotation arm 104 and so that the ridge 144 of the first rotation arm 102 fits within the gap 148 in the second rotation arm 104 to securely hold the pivot joint apparatus 100 at the desired setting. The release of pressure on the button 122 therefore causes the spring mechanism 112 to decompress and bias the engagement piece 106 in the locking portion 108, thereby returning the pivot joint apparatus 100 to a locked position.

Other embodiments for release mechanisms are also contemplated for use in the present invention. In one embodiment, any number of pins may be used to release the engagement piece 106. In another embodiment, the first and second rotation arms 102 and 104 may include levers or switches which, when pressed or activated, cause the first portion 124 to separate from the locking portion 108. In yet another embodiment, activation mechanisms, such as additional push buttons, may be positioned on the first and second rotation arms 102 and 104 to activate the release mechanism 114 extend the series of pins 116. It is noted that any method of causing the release or separation of the first portion 124 of the engagement piece 106 from the locking portion 108 of the second rotation arm 104 is contemplated for use with the present invention.

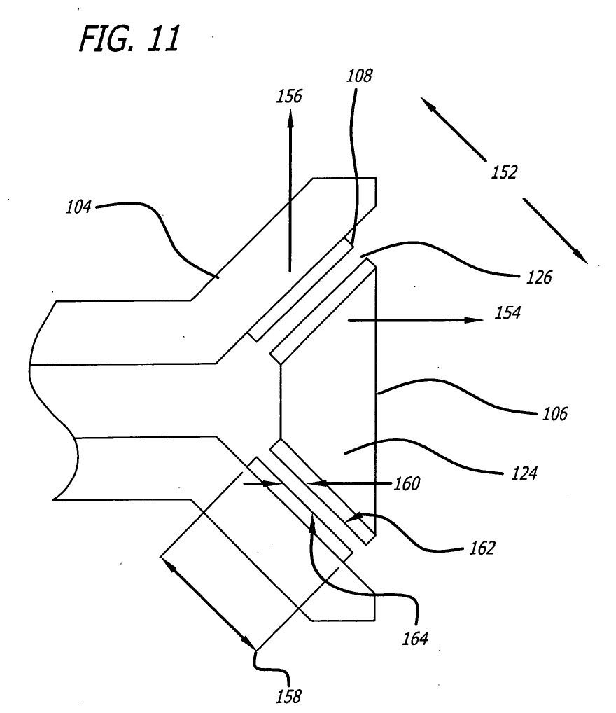

FIG. 11 is a diagrammatic view of particular components of the locking mechanism according to one embodiment of the present invention, showing the first portion 124 of the engagement piece 106 inserting into the locking portion 108 of the second rotation arm 104. In this embodiment, the first portion 124 has a substantially sloped perimeter, and the plurality of teeth 126 along the perimeter are also substantially sloped. The locking portion 108 is also shown to be substantially sloped, to accept the substantially sloped perimeter of the first portion 124. One example of an angle of slope is a 45° angle. In another embodiment, the substantially sloped perimeter of the first portion 124 and the plurality of teeth 126 are conical in shape, and the locking portion 108 is also conical in shape to accept the first portion 124. The conical shape may also employ a 45° angle of slope.

An axial configuration, instead of a sloped or conical configuration, produces a reactive force perpendicular to the plane of engagement. In this type of configuration, the locking components want to disengage due to the reactive forces acting on the pivot joint. A radial configuration, instead of a sloped of conical configuration, produces a reactive force parallel to the plane of engagement. In this type of configuration, the locking components tend to slip over time and damage the teeth as the components become worn.

In the embodiment of FIG. 11, the reactive force 152, or the force trying to disengage or ride over the plurality of teeth, is split by the 45° angle into 50% axial and 50% radial forces, shown by reference numbers 154 and 156, respectively, thus lessening the disengaging effect of the reactive force on the pivot joint. The 45° angle also allows for longer teeth in the plurality of teeth with a greater amount of surface contact 158. This lessens the load per unit of area of contact surface. In addition, the angled entry of engagement of the teeth results in a greater depth of engagement 160 without increasing the height of the profile of the teeth. Further, the sloped or conical configuration allows the pivot joint to be self-aligning after wear.

In another embodiment of the present invention, an adjustable pivot joint apparatus is provided having a plate system which includes interlocking clutch plates which, when separated, allow the apparatus to pivot about an axis. The apparatus also includes a release mechanism and a spring mechanism. The clutch plates prevent the apparatus from pivoting about the axis when in a locked position.

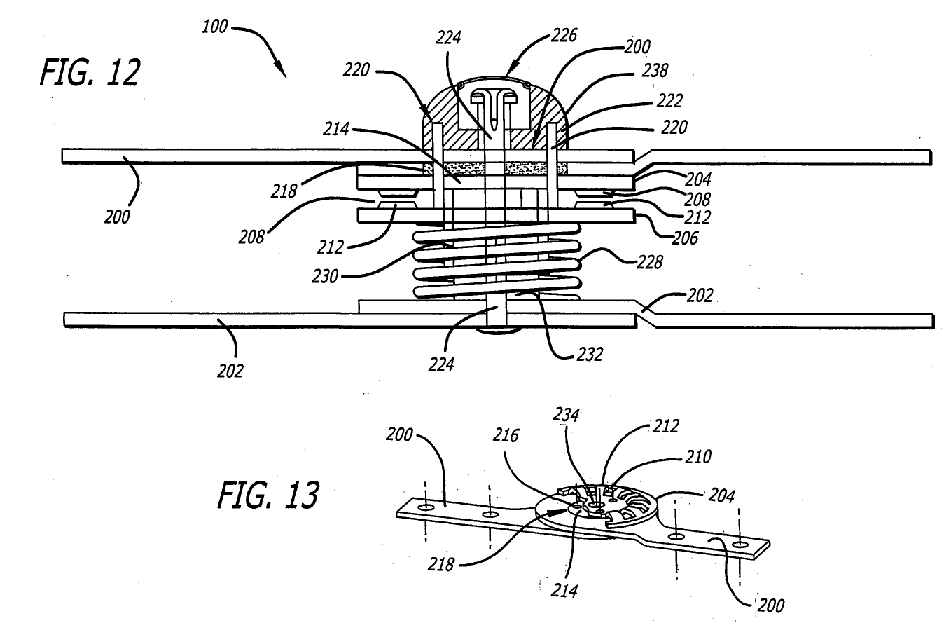

FIG. 12 is a cross-sectional view of a pivot joint apparatus 100 according to the present invention. The pivot joint apparatus 100 of FIG. 12 is shown in an unlocked position. The pivot joint apparatus 100 includes a system of plates. The system of plates includes a first pair of joint plates 200 and a second pair of joint plates 202. The system of plates also includes a first clutch plate 204 and a second clutch plate 206. The first clutch plate 204 may be coupled to the first pair of joint plates 200. The first and second clutch plates 204 and 206 may be substantially circular in shape. The first and second clutch plates 204 and 206 may be made of sheet metal or any other material of suitable strength.

In one embodiment, each of the first and second clutch plates 204 and 206 may include an elevated portion 208. The elevated portion 208 includes a series of grooves 210 and bars 212 between the series of grooves 210. Each of the first and second clutch plates 204 and 206 also include a central portion 214 which may have a series of holes 216 positioned therein.

The first and second clutch plates 204 and 206 may be positioned such that the elevated portions 208 face each other. The bars 212 in the elevated portion 208 of one clutch plate fit into the series of grooves 210 of the elevated portion 208 of the other clutch plate. When the elevated portions 208 fit together, this results in the first and second clutch plates 204 and 206 being in an interlocked, secure position relative to each other, such that neither of the first or second clutch plates 204 and 206 can move laterally until the bars 212 are disengaged from the series of grooves 210.

The first and second clutch plates 204 and 206 may include any number of grooves 210 and bars 212 in their elevated portions 208. Additionally, the grooves 210 and bars 212 may be flat with respect to the other components of the first and second clutch plates 204 and 206, or may be depressed within the first and second clutch plates 204 and 206. Other embodiments for interlocking the first and second clutch plates are also contemplated in the present invention. For example, a gear system may be used to interlock the first and second clutch plates to prevent their movement relative to each other. It is noted that any means of providing interlocking mechanical components can be used with the present invention to achieve a locking system that prevents one or more components from moving.

The pivot joint apparatus 100 also includes a pivot piece 218 positioned in one of the joint plates in the first pair of joint plates 200. The pivot joint apparatus 100 also includes a release mechanism. In one embodiment, the release mechanism has a series of pins 220 housed in a head portion 222. The series of pins 220 penetrate the first pair of joint plates 200, the pivot piece 218, and the first clutch plate 204. The series of pins 220 also contact with the second clutch plate 206 and, when activated by exerting pressure on the head portion 222, cause the second clutch plate 206 to move away from the first clutch plate 204 as described in greater detail below. The head portion 222 may also include a post 224 and a closure cap 226. Each of the first and second clutch plates 204 and 206 include a post hole 234 through which the post 224 passes.

The head portion 222 may also include a housing 238 within which the series of pins 220 and the post 224 are positioned. In one embodiment, the series of pins 220 are activated by pressing or pushing the head portion 222 to force the series of pins 220 to extend down to exert force on the second clutch plate 206. In another embodiment, the closure cap 226 acts as a button which can be pushed to activate the series of pins 220 and force them to extend down to exert force on the second clutch plate 206. In yet another embodiment, activation mechanisms, such as push buttons, may be positioned on the pairs of joint plates 200 or 202 to activate and extend the series of pins 220.

Other embodiments for release mechanisms are also contemplated for use in the present invention. In one embodiment, any number of pins may be used to release the first and second clutch plates. In another embodiment, the joint plates 200 and 202 may include levers or switches which, when pressed or activated, cause the first and second clutch plates to separate. It is noted that any method of causing the release or separation of the first and second clutch plates is contemplated for use with the present invention.

Each joint plate in the first pair of joint plates 200 may be coupled together by the post 224 and the series of pins 220. Each joint plate in the second pair of joint plates 202 may also be coupled together by the post 224.

The pivot piece 218 provides a large, non-rotating diameter about which the pivot joint apparatus 100 can be adjusted. In one embodiment, the pivot piece 218 is a washer positioned adjacent to the central portion 214 of the first clutch plate 204. When the first and second clutch plates 204 and 206 are disengaged, the pivot joint apparatus 100 is adjustable by rotating joint plates in the first and second joint plates 200 and 202 about the pivot piece 218.

The pivot joint apparatus 100 may also include a spring mechanism 228. The second clutch plate 206 includes a first extension 230. One of the joint plates in the second pair of joint plates 202 includes a second extension 232 which is capable of insertion into the first extension 230. The spring mechanism 228 may be a coil wound around the first extension 230 and the second extension 232. The post 224 extends all the way through from the head portion 222 to the second pair of joint plates 202, as shown in FIG. 12.

FIG. 13 is a perspective view of a portion of the system of plates of the pivot joint apparatus 100. The first pair of joint plates 200 and the first clutch plate 204 are shown, with a portion of the first clutch plate 204 removed to show the pivot piece 218. The series of holes 216 through which the series of pins 220 pass extend through the first pair of joint plates 200, the pivot piece 218, and the first clutch plate 204.

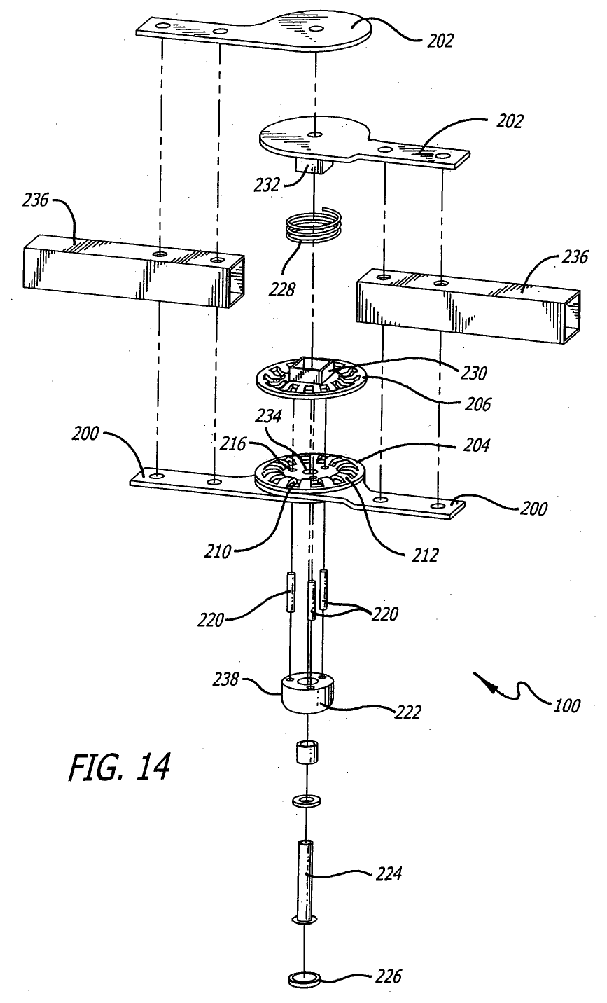

FIG. 14 is a perspective view of the pivot joint apparatus 100 according to the present invention, showing the various components in separated fashion. The pivot joint apparatus 100 may be used with any device or article of manufacture requiring an adjustable pivot joint. FIG. 14 shows members 236 which are securable to the pivot joint apparatus 100. The position of the members 236 can be adjusted by rotating at least one joint plate in each of the first and second pairs of joint plates 200 and 202 together about the pivot piece when the first and second clutch plates 204 and 206 are separated. One example of the use of a pivot joint apparatus 100 according to the present invention is in wheelchairs or strollers. Often, occupants of wheelchair or strollers must adjust the positioning of leg or arm rests or other components. This can be cumbersome for some occupants. Using the present invention, an occupant activates the release mechanism, adjusts the pivot joint apparatus and the component connected thereto to a desired position, and then deactivates the release mechanism. Additionally, the clutch plate locking feature adds strength and durability to the pivot joint component of the wheelchair or stroller. Accordingly, the members 236 are portions of a mechanical component to which the pivot joint apparatus is connected. The members 236 are provided to show a particular use for the pivot joint apparatus of the present invention. It is noted that although various aspects of the present invention are described in the context of wheelchair and strollers, those skilled in the art will appreciate that the pivot joint apparatus of the present invention is likewise suitable for use in various other mechanical environments. Accordingly, any reference to wheelchairs and strollers is intended only to illustrate the inventive aspects of the present invention, with the understanding that such inventive aspects have a wide range of applications.

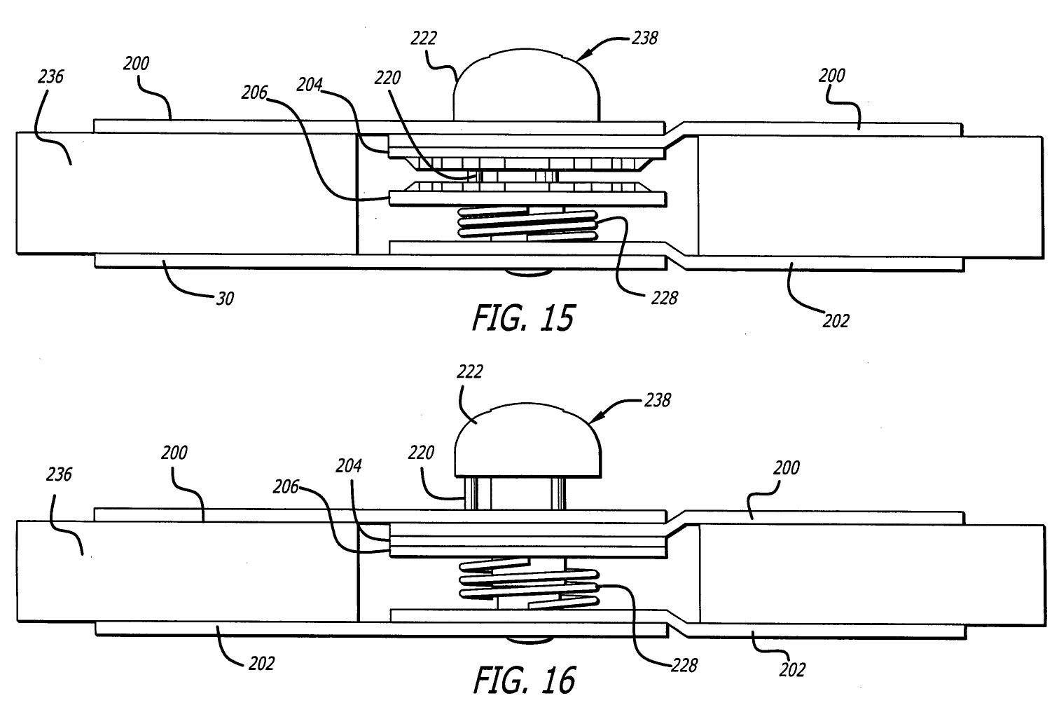

FIG. 15 is a side view of the pivot joint apparatus 100. The pivot joint apparatus 100 of FIG. 15 is in an unlocked position and ready for adjustment. To unlock, or disengage, the first and second clutch plates 204 and 206, the release mechanism is activated to force the series of pins 220 to extend and push the second clutch plate 206 away from the first clutch plate 204. This results in the bars 212 and the series of grooves 210 being disengaged from each other, allowing lateral movement of the first clutch plate 204 relative to the second clutch plate 206. Once the first and second clutch plates 204 and 206 have been disengaged, at least one of the joint plates in the first pair of joint plates 200 can be rotated, in conjunction with at least one joint plate from the second pair of joint plates 202, about the pivot piece 218.

When the series of pins 220 pushes the second clutch plate 206 away from the first clutch plate 204, the second clutch plate 206 pushes against the spring mechanism 228. When not pushed down by the second clutch plate 206 and the series of pins 220, the spring mechanism 228 also serves to bias the second clutch plate 206 against the first clutch plate 204 to provide further stability for the system of plates when the bars 212 and the series of grooves 210 of the first and second clutch plates 204 and 206 are engaged.

FIG. 16 is another side view of the pivot joint apparatus 100. The pivot joint apparatus 100 of FIG. 16 is in a locked position such that the plates making up the system of plates do not move. In FIG. 16, the first and second clutch plates 204 and 206 are engaged in a locked position, preventing the system of plates, and therefore the pivot joint apparatus itself, from moving. Additionally, the spring mechanism 228 biases the second clutch plate 206 against the first clutch plate 204.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A pivot joint comprising:
a first rotation arm and a second rotation arm, the first rotation arm coupled to an engagement piece having at least one portion with an angled perimeter, and the second rotation arm having a locking portion also having an angled perimeter, wherein the angled perimeters of the at least one portion of the engagement piece and the locking portion allow the locking portion to receive the engagement piece to provide a locking mechanism for the pivot joint;
a pivot piece about which the first rotation arm and the second rotation arm are rotatable, and a spring mechanism positioned around the pivot piece and between the first rotation arm and the second rotation arm;
a release mechanism having a series of pins, the second rotation arm having a series of holes through which the series of pins are positioned, wherein the series of pins extend through the series of holes to move the engagement piece against the spring mechanism and out of the locking portion when the release mechanism is activated to allow at least one of the first rotation arm and the second rotation arms to move relative to the other.

2. The pivot joint of claim 1, wherein the spring mechanism allows the engagement piece to disengage the locking portion when pressure is applied to move the first and second rotation arms toward each other, and allows the engagement piece to engage the locking portion to maintain the pivot joint in a locked position when no pressure is applied to rotate the at least one of the first and second rotation arms relative to the other.

3. The pivot joint of claim 1, wherein the release mechanism includes a head portion having a button coupled to the series of pins.

4. The pivot joint of claim 1, wherein the series of pins are contoured to securely fit into the series of holes to prevent movement of the release mechanism.

5. The pivot joint of claim 1, wherein the at least one portion of the engagement piece is a first, conical portion having a plurality of teeth, and wherein the engagement piece also includes a second, square portion coupled to the first, conical portion.

6. The pivot joint of claim 5, wherein the plurality of teeth of the first, conical portion fit into a plurality of grooves in the locking portion of the second rotation arm.

7. The pivot joint of claim 6, wherein the locking portion is recessed within the second rotation arm and has a conical configuration to accept the first, conical portion of the engagement piece.

8. The pivot joint of claim 7, wherein the second, square portion fits into a recessed portion of the first rotation arm.

9. The pivot joint of claim 8, wherein the spring mechanism biases the engagement piece toward the second rotation arm when in an uncompressed position to cause the first, conical portion of the engagement piece to engage the locking portion of the second rotation arm.

10. The pivot joint of claim 9, wherein activating the series of pins causes the spring mechanism to compress and moves the second, square portion of the engagement piece into the recessed portion of the first rotation arm, causing the first rotation arm and the engagement piece to move together relative to the second arm rotation arm to allow adjustment of the pivot joint.

11. The pivot joint of claim 10, wherein when activated, the series of pins disengage the plurality of teeth of the engagement piece from the plurality of grooves from the locking portion.

12. The pivot joint of claim 11, wherein when the plurality of teeth of the engagement piece engage the plurality of grooves of the locking portion, the first rotation arm is prevented from rotating relative to the second rotation arm.

13. The pivot joint of claim 1, wherein the pivot piece provides a non-rotating diameter about which the pivot joint can be adjusted.

14. The pivot joint of claim 13, wherein the pivot piece is centrally positioned within the first rotation arm, the engagement piece, the second rotation arm, and the release mechanism.

15. A pivot joint comprising:
a rotation mechanism having a first rotation arm coupled to an engagement piece and a locking portion recessed within a second rotation arm, the engagement piece having a plurality of teeth, and the locking portion having a plurality of grooves, such that when the engagement piece is positioned within the locking portion and the plurality of teeth and the plurality of grooves are aligned together, the rotation mechanism lockably engages the first rotation arm and the second rotation arm; and
a release mechanism configured to disengage the first rotation arm and the second rotation arm by removing the plurality of teeth from the plurality of grooves when a spring mechanism positioned between the first rotation arm and the second rotation arm is compressed.

16. The pivot joint of claim 15, further comprising a pivot piece about which at least one of the first rotation arm and the second rotation arm is rotatable.

17. The pivot joint of claim 15, wherein the release mechanism includes a head portion having a button and a series of pins positioned in and extending from the head portion, the second rotation arm having a series of holes through which the series of pins are positioned.

18. The pivot joint of claim 17, wherein application of pressure to the release mechanism causes the series of pins to extend through the series of holes to push the engagement piece against the spring mechanism and out of the locking portion to allow at least one of the first rotation arm and the second rotation arms to move relative to the other.

19. The pivot joint of claim 16, wherein the spring mechanism is positioned around the pivot piece.

20. The pivot joint of claim 17, wherein the series of pins are contoured to securely fit into the series of holes to prevent movement of the release mechanism.

21. The pivot joint of claim 18, wherein the engagement piece includes a first, conical portion having the plurality of teeth and second, square portion coupled to the first, conical portion.

22. The pivot joint of claim 21, wherein the plurality of teeth of the first, conical portion fit into the plurality of grooves in the locking portion of the second rotation arm.

23. The pivot joint of claim 22, wherein the locking portion is recessed within the second rotation arm and has a conical configuration to accept the first, conical portion of the engagement piece.

24. The pivot joint of claim 23, wherein the second, square portion fits into a recessed portion of the first rotation arm.

25. The pivot joint of claim 24, wherein the spring mechanism biases the engagement piece toward the second rotation arm when in an uncompressed position to cause the first, conical portion of the engagement piece to engage the locking portion of the second rotation arm.

26. The pivot joint of claim 25, wherein activating the series of pins causes the spring mechanism to compress and moves the second, square portion of the engagement piece into the recessed portion of the first rotation arm, causing the first rotation arm and the engagement piece to move together relative to the second arm rotation arm to allow adjustment of the pivot joint.

27. The pivot joint of claim 26, wherein when activated, the series of pins disengage the plurality of teeth of the engagement piece from the plurality of grooves from the locking portion.

28. The pivot joint of claim 27, wherein when the plurality of teeth of the engagement piece engage the plurality of grooves of the second rotation arm, the first rotation arm is prevented from rotating relative to the second rotation arm.

29. The pivot joint of claim 15, wherein the pivot piece provides a non-rotating diameter about which the pivot joint can be adjusted.

30. The pivot joint of claim 29, wherein the pivot piece is centrally positioned within the first rotation arm, the engagement piece, the second rotation arm, and the release mechanism.

31. A method of pivoting a joint apparatus, comprising:
providing a first rotation arm and a second rotation arm, the first rotation arm coupled to an engagement piece having at least one portion with a sloped perimeter, and the second rotation arm having a locking portion also having a sloped perimeter capable of receiving the at least one portion of the engagement piece;
releasing the engagement piece from the locking portion by moving the first rotation arm to apply pressure against a spring mechanism;
rotating at least one of the first and second rotation arms around a pivot piece; and
locking the first and second rotation arms in a desired position by releasing pressure on the spring mechanism and engaging the engagement piece and the locking portion to prevent the first and second rotation arms from moving relative to each other.

32. The method of claim 31, wherein the releasing the engagement piece from the locking portion by moving the first rotation arm to apply pressure against a spring mechanism includes activating a release mechanism having a head portion and a button coupled to a series of pins positionable in a series of holes in the second rotation arm, wherein activation of the release mechanism causes the series of pins to extend through the series of holes to move the engagement piece against the spring mechanism and out of the locking portion.

33. The method of claim 31, wherein the spring mechanism is positioned around the pivot piece and between the first rotation arm and the second rotation arm.

34. The method of claim 32, wherein the series of pins are contoured to securely fit into the series of holes to prevent movement of the release mechanism.

35. The method of claim 34, wherein the at least one portion of the engagement piece is a first, conical portion having a plurality of teeth, and wherein the engagement piece also includes a second, square portion coupled to the first, conical portion.

36. The method of claim 35, wherein the plurality of teeth of the first, conical portion fit into a plurality of grooves in the locking portion of the second rotation arm.

37. The method of claim 36, wherein the locking portion is recessed within the second rotation arm and has a conical configuration to accept the first, conical portion of the engagement piece.

38. The method of claim 37, wherein the second, square portion fits into a recessed portion of the first rotation arm.

39. The method of claim 38, wherein the spring mechanism biases the engagement piece toward the second rotation arm when in an uncompressed position to cause the first, conical portion of the engagement piece to engage the recessed locking portion of the second rotation arm.

40. The method of claim 39, wherein activating the series of pins causes the spring mechanism to compress and moves the second, square portion of the engagement piece into the recessed portion of the first rotation arm, causing the first rotation arm and the engagement piece to move together relative to the second arm rotation arm to allow adjustment of the pivot joint.

41. The method of claim 40, wherein when activated, the series of pins disengage the plurality of teeth of the engagement piece from the plurality of grooves from the locking portion.

42. The method of claim 41, wherein when the plurality of teeth of the engagement piece engage the plurality of grooves of the second rotation arm, the first rotation arm is prevented from rotating relative to the second rotation arm.

43. The method of claim 31, wherein the pivot piece provides a non-rotating diameter about which the pivot joint can be adjusted.

44. The method of claim 43, wherein the pivot piece is centrally positioned within the first rotation arm, the engagement piece, the second rotation arm, and the activation mechanism.
